(19) United States
(12) Patent Application Publication
(10) Pub. No.: US 2014/0141230 A1
(43) Pub. Date: May 22, 2014

(54) PERMANENT ATTACHMENT OF AMMONIUM AND GUANIDINE-BASED ANTIMICROBIALS TO SURFACES CONTAINING C-H FUNCTIONALITY

(71) Applicant: Jason J. Locklin, Bogart, GA (US)

(72) Inventor: Jason J. Locklin, Bogart, GA (US)

(21) Appl. No.: 14/114,914

(22) PCT Filed: Aug. 2, 2012
(86) PCT No.: PCT/US12/49257

§ 371 Date: Oct. 31, 2013

Related U.S. Application Data
(60) Provisional application No. 61/514,961, filed on Aug. 4, 2011.

(51) Int. Cl. A01N 25/10; A01N 25/08; A01N 47/44; A01N 33/12

(52) U.S. Cl. CPC A01N 25/10; A01N 33/12; A01N 25/08; A01N 47/44
USPC 428/221; 564/283; 564/235; 525/333.7; 536/30; 525/418; 525/420; 525/326.1; 524/1; 428/473; 428/457; 428/704

(57) ABSTRACT

Embodiments of the present disclosure, in one aspect, relate to compounds, methods of making compounds, structures having the compound covalently bonded to the surface of the structure, methods of attaching the compound to the surface of the structure, methods of decreasing the amount of microorganisms formed on a structure, and the like.

### CROSS-REFERENCE TO RELATED APPLICATION

This application claims priority to U.S. provisional application entitled “PERMANENT ATTACHMENT OF AMMONIUM AND GUANIDINE-BASED ANTIMICROBIALS TO SURFACES CONTAINING C—H FUNCTIONALITY,” having Ser. No. 61/514,961 filed on Aug. 4, 2011, which is entirely incorporated herein by reference.

### BACKGROUND

Covalent attachment of antimicrobial agents to structures such as fabrics can be challenging. Thus, solutions for attaching antimicrobial agents to structures are actively being pursued.

### SUMMARY

Embodiments of the present disclosure, in one aspect, relate to compounds, methods of making compounds, structures having the compound covalently bonded to the surface of the structure, methods of attaching the compound to the surface of the structure, methods of decreasing the amount of microorganisms formed on a structure, and the like.

An embodiment of the present disclosure can include a compound having a photo cross-linkable moiety and an antimicrobial moiety (AM). In an embodiment, the photo cross-linkable moiety and an antimicrobial moiety are defined by the following: R11-(C═O)-R12-X-(AM), where R11 and R12 are independently selected from the group consisting of: H, a substituted or unsubstituted aliphatic group, a substituted or unsubstituted aryl group, and a substituted or unsubstituted heteroaryl group; X is selected from the group consisting of: O, NR13, a substituted or unsubstituted alkyl group, an S group, a SR13 group, a substituted or unsubstituted aryl group, and a substituted or unsubstituted heteroaryl group; wherein R13 is selected from the group consisting of: H, a substituted or unsubstituted aliphatic group, a substituted or unsubstituted aryl group, and a substituted or unsubstituted heteroaryl group.

An embodiment of the compound, among others, includes an article having a compound having a photo cross-linkable moiety and an antimicrobial moiety (AM). In an embodiment, the article can be represented by: R11-(C(Struc)OH)-R12-X-(AM), where R11 and R12 are independently selected from the group consisting of: H, a substituted or unsubstituted aliphatic group, a substituted or unsubstituted aryl group, and a substituted or unsubstituted heteroaryl group; X is selected from the group consisting of: O, NR13, a substituted or unsubstituted alkyl group, a S group, a substituted or unsubstituted aryl group, and a substituted or unsubstituted heteroaryl group; wherein R13 is selected from the group consisting of: H, a substituted or unsubstituted aliphatic group, a substituted or unsubstituted aryl group, and a substituted or unsubstituted heteroaryl group, and wherein Struc is a structure having C—H functionality.

### DETAILED DESCRIPTION

Before the present disclosure is described in greater detail, it is to be understood that this disclosure is not limited to particular embodiments described, as such may, of course, vary.

It is also to be understood that the terminology used herein is for the purpose of describing particular embodiments only, and is not intended to be limiting, since the scope of the present disclosure will be limited only by the appended claims.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited.

The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features that may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, polymer chemistry, biology, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in atmospheres. Standard temperature and pressure are defined as 25° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### DEFINITIONS

The term “substituted” refers to any one or more hydrogens on the designated atom that can be replaced with a selection from the indicated group, provided that the designated atom's normal valence is not exceeded, and that the substitution results in a stable compound. In an embodiment, the indicated group can include in or more halogens, aliphatic groups, and the like.

The term “aliphatic group” refers to a saturated or unsaturated linear or branched hydrocarbon group and encompasses alkyl, alkenyl, and alkynyl groups, for example.

As used herein, “alkyl” or “alkyl group” refers to a saturated aliphatic hydrocarbon chain and a substituted saturated aliphatic hydrocarbon chain which may be straight, branched, or cyclic, having 1 to 20 carbon atoms, where the stated range of carbon atoms includes each intervening integer individually, as well as sub-ranges. Examples of alkyl groups include, but are not limited to, methyl, ethyl, i-propyl, n-propyl, n-butyl, t-butyl, pentyl, hexyl, septyl, octyl, nonyl, decyl, and the like. The substitution can be with a halogen, for example.

As used herein, “alkenyl” or “alkenyl group” refers to an aliphatic hydrocarbon which can be straight or branched, containing at least one carbon-carbon double bond, having 2 to 20 carbon atoms, wherein the stated range of carbon atoms includes each intervening integer individually, as well as sub-ranges. Examples of alkenyl groups include, but are not limited to, ethenyl, propenyl, n-butenyl, i-butenyl, 3-methylbut-2-enyl, n-pentenyl, heptenyl, octenyl, decenyl, and the like.

The term “alkynyl” refers to straight or branched chain hydrocarbon groups, containing at least one triple carbon to carbon bond having 2 to 20 carbon atoms, wherein the stated range of carbon atoms includes each intervening integer individually, as well as sub-ranges. An alkynyl group can be optionally substituted, unless stated otherwise, with one or more groups.

The term “arylalkyl” refers to an arylalkyl group wherein the aryl and alkyl are as herein described. Examples of arylalkyl include, but are not limited to, -phenylmethyl, -phenylethyl, -phenylpropyl, -phenylbutyl, and -phenylpentyl.

The term “aryl” refer to aromatic homocyclic (i.e., hydrocarbon) mono-, bi- or tricyclic ring-containing groups preferably having 6 to 12 members such as phenyl, naphthyl and biphenyl. The term “substituted aryl” refers to aryl groups substituted with one or more groups, preferably selected from alkyl, substituted alkyl, alkenyl (optionally substituted), aryl (optionally substituted), heterocyclo (optionally substituted), halo, hydroxy, alkoxy (optionally substituted), aryloxy (optionally substituted), alkanoyl (optionally substituted), aroyl, (optionally substituted), alkylester (optionally substituted), arylester (optionally substituted), cyano, nitro, amino, substituted amino, amido, lactam, urea, urethane, sulfonyl, etc., where optionally one or more pair of substituents together with the atoms to which they are bonded form a 3 to 7 member ring.

The term “heteroaryl” is used herein to denote an aromatic ring or fused ring structure of carbon atoms with one or more non-carbon atoms, such as oxygen, nitrogen, and sulfur, in the ring or in one or more of the rings in fused ring structures. Examples are furanyl, pyranyl, thienyl, imidazyl, pyrrolyl, pyridyl, pyrazolyl, pyrazinyl, pyrimidinyl, indolyl, quinolyl, isoquinolyl, quinoxalyl, and quinazolinyl. Preferred examples are furanyl, imidazyl, pyranyl, pyrrolyl, and pyridyl.

The term “substituted,” as in “substituted alkyl”, “substituted cycloalkyl,” “substituted cycloalkenyl,” substituted aryl, “substituted biaryl,” “substituted fused aryl” and the like means that the substituted group may contain in place of one or more hydrogens a group such as hydroxy, amino, halo, trifluoromethyl, cyano, —NH(lower alkyl), —N(lower alkyl)₂, lower alkoxy, lower alkylthio, or carboxy, and thus embraces the terms haloalkyl, alkoxy, fluorobenzyl, and the sulfur and phosphorous containing substitutions referred to below.

As used herein, “halo”, “halogen”, or “halogen radical” refers to a fluorine, chlorine, bromine, and iodine, and radicals thereof. Further, when used in compound words, such as “haloalkyl” or “haloalkenyl”, “halo” refers to an alkyl or alkenyl group in which one or more hydrogens are substituted by halogen radicals. Examples of haloalkyl include, but are not limited to, trifluoromethyl, trichloromethyl, pentafluoroethyl, and pentachloroethyl.

As used herein, “halo”, “halogen”, or “halogen radical” refers to a fluorine, chlorine, bromine, and iodine, and radicals thereof. Further, when used in compound words, such as “haloalkyl” or “haloalkenyl”, “halo” refers to an alkyl or alkenyl group in which one or more hydrogens are substituted by halogen radicals. Examples of haloalkyl include, but are not limited to, trifluoromethyl, trichloromethyl, pentafluoroethyl, and pentachloroethyl.

As used herein, the term “fiber” refers to filamentous material that can be used in fabric and yarn as well as textile fabrication. One or more fibers can be used to produce a fabric or yarn. Fibers include, without limitation, materials such as cellulose, fibers of animal origin (e.g., alpaca, angora, wool and vicuna), hemicellulose, lignin, polyesters, polyamides, rayon, modacrylic, aramids, polyacetates, polyxanthates, acrylics and acrylonitriles, polyvinyls and functionalized derivatives, polyvinylidenes, PTFE, latex, polystyrene-butadiene, polyethylene, polyacetylene, polycarbonates, polyethers and derivatives, polyurethane-polyurea copolymers, polybenzimidazoles, silk, lyocell, carbon fibers, polyphenylene sulfides, polypropylene, polylactides, polyglycolids, cellophane, polycaprolactone, “M5” (poly{diimidazo pyridinylene(dihydroxy)phenylene}), melamine-formadehyde, plastarch, PPOs (e.g., Zylon®), polyolefins, and polyurethane. In an embodiment, the fiber is made of polyethylene, polyester, aramid, polyamide, cellulose, hemicellulose, acrylic, and latex.

The term “textile article” can include garments, fabrics, carpets, apparel, furniture coverings, drapes, upholstery, bedding, automotive seat covers, fishing nets, rope, articles including fibers (e.g., natural fibers, synthetic fibers, and combinations thereof), articles including yarn (e.g., natural fibers, synthetic fibers, and combinations thereof), and the like.

The term “antimicrobial characteristic” refers to the ability to kill and/or inhibit the growth of microorganisms. A substance having an antimicrobial characteristic may be harmful to microorganisms (e.g., virus, bacteria, fungi, protozoans, algae, and the like). A substance having an antimicrobial characteristic can kill the microorganism and/or prevent or substantially prevent the growth or reproduction of the microorganism. “Antimicrobial” includes antibacterial and antiviral.

The term “antiviral characteristic” refers to the ability to kill and/or inhibit the growth of a virus. A substance having an antiviral characteristic may be harmful to a virus. A substance having an antiviral characteristic can kill the virus and/or prevent or substantially prevent the replication or reproduction of the virus.

Viruses which may be inhibited by compounds of the present disclosure include, but are not limited to: Adenoviruses, Coronaviruses, Cytomegalovirus, Enteroviruses, Epstein-Barr virus, Herpes simplex virus, Hepatitis viruses, Human Immunodeficiency virus, Human Parvoviruses, Influenza viruses, Morbillivirus, Mumps virus, Norwalk viruses, Papillomaviruses, Paromyxovirus, Poxvirus, Rabies virus, Reoviruses, Rotaviruses, Rubella virus, Respiratory Synctial virus, Rhinoviruses, Varicella zoster virus, and the like.

The term “antibacterial characteristic” refers to the ability to kill and/or inhibit the growth of bacteria. A substance having an antibacterial characteristic may be harmful to bacteria. A substance having an antibacterial characteristic can kill the bacteria and/or prevent or substantially prevent the replication or reproduction of the bacteria.

The terms “bacteria” or “bacterium” include, but are not limited to, Gram positive and Gram negative bacteria. Bacteria can include, but are not limited to, Abiotrophia, Achromobacter, Acidaminococcus, Acidovorax, Acinetobacter, Actinobacillus, Actinobaculum, Actinomadura, Actinomyces, Aerococcus, Aeromonas, Afipia, Agrobacterium, Alcaligenes, Alloiococcus, Alteromonas, Amycolata, Amycolatopsis, Anaerobospirillum, Anabaena affinis and other cyanobacteria (including the Anabaena, Anabaenopsis, Aphanizomenon, Carnesiphon, Cylindrospermopsis, Gloeobacter Hapalosiphon, Lyngbya, Microcystis, Nodularia, Nostoc, Phormidium, Planktothrix, Pseudoanabaena, Schizothrix, Spirulina, Trichodesmium, and Umezakia genera) Anaerorhabdus, Arachnia, Arcanobacterium, Arcobacter, Arthrobacter, Atopobium, Aureobacterium, Bacteroides, Balneatrix, Bartonella, Bergeyella, Bifidobacterium, Bilophila Branhamella, Borrelia, Bordetella, Brachyspira, Brevibacillus, Brevibacterium, Brevundimonas, Brucella, Burkholderia, Buttiauxella, Butyrivibrio, Calymmatobacterium, Campylobacter, Capnocytophaga, Cardiobacterium, Catonella, Cedecea, Cellulomonas, Centipeda, Chlamydia, Chlamydophila, Chromobacterium, Chyseobacterium, Chryseomonas, Citrobacter, Clostridium, Collinsella, Cornamonas, Corynebacterium, Coxiella, Cryptobacterium, Delffia, Dermabacter, Dermatophilus, Desulfomonas, Desulfovibrio, Dialister, Dichelobacter, Dolosicoccus, Dolosigranulum, Edwardsiella, Eggerthella, Ehrlichia, Eikenella, Empedobacter, Enterobacter, Enterococcus, Erwinia, Erysipelothrix, Escherichia, Eubacterium, Ewingella, Exiguobacterium, Facklamia, Filifactor, Flavimonas, Flavobacterium, Francisella, Fusobacterium, Gardnerella, Gemella, Globicatella, Gordona, Haemophilus, Hafnia, Helicobacter, Helococcus, Holdemania Ignavigranum, Johnsonella, Kingella, Klebsiella, Kocuria, Koserella, Kurthia, Kytococcus, Lactobacillus, Lactococcus, Lautropia, Leclercia, Legionella, Leminorella, Leptospira, Leptotrichia, Leuconostoc, Listeria, Listonella, Megasphaera, Methylobacterium, Microbacterium, Micrococcus, Mitsuokella, Mobiluncus, Moellerella, Moraxella, Morganella, Mycobacterium, Mycoplasma, Myroides, Neisseria, Nocardia, Nocardiopsis, Ochrobactrum, Oeskovia, Oligella, Orientia, Paenibacillus, Pantoea, Parachlamydia, Pasteurella, Pediococcus, Peptococcus, Peptostreptococcus, Photobacterium, Photorhabdus, Phytoplasma, Plesiomonas, Porphyrimonas, Prevotella, Propionibacterium, Proteus, Providencia, Pseudomonas, Pseudonocardia, Pseudoramibacter, Psychrobacter, Rahnella, Ralstonia, Rhodococcus, Rickettsia Rochalimaea Roseomonas, Rothia, Ruminococcus, Salmonella, Selenomonas, Serpulina, Serratia, Shewenella, Shigella, Simkania, Slackia, Sphingobacterium, Sphingomonas, Spirillum, Spiroplasma, Staphylococcus, Stenotrophomonas, Stomatococcus, Streptobacillus, Streptococcus, Streptomyces, Succinivibrio, Sutterlla, Suttonella, Tatumella, Tissierella, Trabulsiella, Treponema, Tropheryma, Tsakamurella, Turicella, Ureaplasma, Vagococcus, Veillonella, Vibrio, Weeksella, Wolinella, Xanthomonas, Xenorhabdus, Yersinia, and Yokenella. Other examples of bacterium include Mycobacterium tuberculosis, M. bovis, M. typhimurium, M. bovis strain BCG, BCG substrains, M. avium, M. intracellulare, M. africanum, M. kansasii, M. marinum, M. ulcerans, avium subspecies paratuberculosis, Staphylococcus aureus, Staphylococcus epidermidis, Staphylococcus equi, Streptococcus pyogenes, Streptococcus agalactiae, Listeria monocytogenes, Listeria ivanovii, Bacillus anthracis, B. subtilis, Nocardia asteroides, and other Nocardia species, Streptococcus viridans group, Peptococcus species, Peptostreptococcus species, Actinomyces israelii and other Actinomyces species, and Propionibacterium acnes, Clostridium tetani, Clostridium botulinum, other Clostridium species, Pseudomonas aeruginosa, other Pseudomonas species, Campylobacter species, Vibrio cholera, Ehrlichia species, Actinobacillus pleuropneumoniae, Pasteurella haemolytica, Pasteurella multocida, other Pasteurella species, Legionella pneumophila, other Legionella species, Salmonella typhi, other Salmonella species, Shigella species Brucella abortus, other Brucella species, Chlamydi trachomatis, Chlamydia psittaci, Coxiella burnetti, Escherichia coli, Neiserria meningitidis, Neiserria gonorrhea, Haemophilus influenzae, Haemophilus ducreyi, other Hemophilus species, Yersinia pestis, Yersinia enterolitica, other Yersinia species, Escherichia coli, E. hirae and other Escherichia species, as well as other Enterobacteria, Brucella abortus and other Brucella species, Burkholderia cepacia, Burkholderia pseudomallei, Francisella tularensis, Bacteroides fragilis, Fudobascterium nucleatum, Provetella species, and Cowdria ruminantium, or any strain or variant thereof. The Gram-positive bacteria may include, but is not limited to, Gram positive Cocci (e.g., Streptococcus, Staphylococcus, and Enterococcus). The Gram-negative bacteria may include, but is not limited to, Gram negative rods (e.g., Bacteroidaceae, Enterobacteriaceae, Vibrionaceae, Pasteurellae and Pseudomonadaceae). In an embodiment, the bacteria can include Mycoplasma pneumoniae.

The term “protozoan” as used herein includes, without limitations flagellates (e.g., Giardia lamblia), amoeboids (e.g., Entamoeba histolitica), and sporozoans (e.g., Plasmodium knowlesi) as well as ciliates (e.g., B. coli). Protozoan can include, but it is not limited to, Entamoeba coli, Entamoeabe histolitica, Iodoamoeba buetschlii, Chilomastix meslini, Trichomonas vaginalis, Pentatrichomonas homini, Plasmodium vivax, Leishmania braziliensis, Trypanosoma cruzi, Trypanosoma brucei, and Myxoporidia.

The term “algae” as used herein includes, without limitations microalgae and filamentous algae such as Anacystis nidulans, Scenedesmus sp., Chlamydomonas sp., Clorella sp., Dunaliella sp., Euglena sp., Prymnesium sp., Porphyridium sp., Synechoccus sp., Botryococcus braunii, Crypthecodinium cohnii, Cylindrotheca sp., Microcystis sp., Isochrysis sp., Monallanthus salina, M. minutum, Nannochloris sp., Nannochloropsis sp., Neochloris oleoabundans, Nitzschia sp., Phaeodactylum tricornutum, Schizochytrium sp., Senedesmus obliquus, and Tetraselmis sueica as well as algae belonging to any of Spirogyra, Cladophora, Vaucheria, Pithophora and Enteromorpha genera.

### Discussion

In accordance with the purpose(s) of the present disclosure, as embodied and broadly described herein, embodiments of the present disclosure, in one aspect, relate to compounds, methods of making compounds, structures having the compound covalently bonded to the surface of the structure, methods of attaching the compound to the surface of the structure, methods of decreasing the amount of microorganisms formed on a structure, and the like. In an embodiment, the compound includes a photo cross-linkable moiety and an antimicrobial moiety. In an embodiment, the compound (or the compound disposed on a surface) has an antimicrobial characteristic (e.g., kills at least 70%, at least 80%, at least 90%, at least 95%, or at least 99% of the microorganisms (e.g., bacteria, virus, a combination of different types microorganisms) and/or reduces the amount of microorganisms that form or grow on the surface by at least 70%, at least 80%, at least 90%, at least 95%, or at least 99%, as compared to a surface without the compound disposed on the surface). Additional details are described herein.

In an embodiment, the compound can be used to bind to a surface or structure of an article having C—H functionality. In an embodiment, the article can include those that are exposed to microorganisms and/or that microorganisms can grow on such as, without limitation, fibers, fabrics, cooking counters, food processing facilities, kitchen utensils, food packaging, swimming pools, metals, drug vials, medical instruments, medical implants, yarns, fibers, gloves, furniture, plastic devices, toys, diapers, leather, tiles, and flooring materials. In an embodiment, the fiber can include: a polypropylene fiber, a polyethylene fiber, a polyester fiber, a polyamide fiber, an aramid fiber, a cellulose fiber, a hemicellulose fiber, an acrylic fiber, a latex fiber, and a natural fiber, as well as natural surfaces, or another surface or structure having C—H functionality.

In an embodiment, the structure may also include live biologic structures (or surfaces of live biologic structures) such as seeds for agricultural uses, tree limbs, and trunk, as well as teeth. In an embodiment, the structure inherently includes C—H groups on the surface of the structure to interact with the compound, as described below.

In an embodiment, the structure includes a functionalized layer disposed on the structure that includes the C—H group on the surface to interact with the compound. In an embodiment, the structure can include surfaces that inherently include a C—H group on the surface of the structure and also can include surfaces that include a functionalized layer disposed on the structure that includes the C—H group. In an embodiment, the functionalized layer can have a thickness of about 2 nanometers (nm) to 1 micrometer (μm) or about 25 nm to 120 nm.

In an embodiment, the structure can include textile articles, fibers, filters or filtration units (e.g., HEPA for air and water), packaging materials (e.g., food, meat, poultry, and the like food packaging materials), plastic structures (e.g., made of a polymer or a polymer blend), glass or glass like structures having a functionalized layer (e.g., includes a C—H group) on the surface of the structure, metals, metal alloys, or metal oxides structure having a functionalized layer (e.g., includes a C—H group) on the surface of the structure, a structure (e.g., tile, stone, ceramic, marble, granite, or the like) having a functionalized layer (e.g., includes a C—H group) on the surface of the structure, and a combination thereof.

In an embodiment, the compound can have the following formula: R11-(C═O)-R12-X-(AM), where AM is an antimicrobial agent such as Q or W. In an embodiment, a composition of a compound can include the same or different types of antimicrobial agents. In other words, the composition or compound can include a single type of antimicrobial agent or a plurality of types of antimicrobial agents.

In an embodiment, the compound functions to at least undergo a photochemical change to covalently bond with a surface or a layer on the surface of the article having a C—H group. In an embodiment, the compound is covalently bonded via the interaction of the compound with a UV light (e.g., about 250 nm to 500 nm or about 340 to 370 nm) that causes a C—C bond to form between the compound and the surface having a C—H group or a layer on the surface having the C—H group. The UV light can be generated from a UV light source such as those known in the art.

In other words, the compound can be attached to the surface or the layer on the surface through a photochemical process so the bonding is easy and inexpensive to achieve. Once the covalent bonds are formed, the compound layer is strongly bound to the surface and can withstand very harsh conditions such as sonication and extended washing steps as well as exposure to harsh environmental conditions (e.g., heat, cold, humidity, lake, river, and ocean conditions (e.g., above and/or under water), and the like).

In an embodiment, R11 and R12 are independently selected from H, an aliphatic group (substituted or unsubstituted and/or linear, branched, or cyclic) (e.g., alkyl, alkenyl, alkynyl), an aryl group (substituted or unsubstituted), or a heteroaryl group (substituted or unsubstituted). In an embodiment, at least one of R11 and R12 is a substituted or unsubstituted aryl group. In an embodiment, at least one of R11 and R12 is a substituted or unsubstituted phenyl group.

In an embodiment, X can be, an aliphatic group (substituted or unsubstituted and/or linear, branched, or cyclic) (e.g., alkyl, alkenyl, alkynyl), an aryl group (substituted or unsubstituted), a heteroaryl group (substituted or unsubstituted), an oxygen group (e.g., O-R13), an amine group (e.g., primary, secondary, or tertiary, where each can have an appropriate number of R13 groups that are independently selected), a sulfur group (e.g., S-R13, wherein one or more R13 can be present), and the like. In an embodiment, R13 can be H, an aliphatic group (substituted or unsubstituted and/or linear, branched or cyclic), an aromatic group (substituted or unsubstituted), an aryl group (substituted or unsubstituted), a heteroaryl group (substituted or unsubstituted), and the like.

In an embodiment, the photo cross-linkable moiety can include an aryl ketone (about 340 to 400 nm), an aryl azide group (about 250 to 450 nm or about 350 to 375 nm), a diazirine group (about 340 to 375 nm), and the compound can include a combination of these groups. In an embodiment, the aryl ketone group can include benzophenone (about 340 to 380 nm), acetophenone (about 340 to 400 nm), a naphthylmethylketone (about 320 to 380 nm), a dinaphthylketone (about 310 to 380 nm), a dinaphtylketone derivative (about 320 to 420 nm), or derivatives of each of these. In an embodiment, the photo cross-linkable moiety is a benzophenone group. In an embodiment, the aryl azide group can include phenyl azide, alkyl substituted phenyl azide, halogen substituted phenyl azide, or derivatives of each of these. In an embodiment, the diazirine group can include 3,3 dialkyl diazirine (e.g., 3,3 dimethyl diazirine, 3,3 diethyl diazirine), 3,3 diaryl diazirine (e.g., 3,3 diphenyl diazirine), 3-alkyl 3-aryl diazirine, (e.g., 3-methyl-3-phenyl diazirine), or derivatives of each of these.

Q is an antimicrobial moiety as described herein.

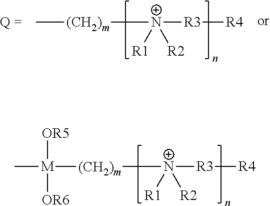

In an embodiment, R1 and R2 can each be independently selected from H, an alkyl group (e.g., CH₃, C₂H₅, CH₂CF₃), or an aryl group (e.g., C₆H₆). In an embodiment, R1 and R2 can each be independently selected from CH₃ and C₂H₅. In an embodiment, R3 can be a linear hydrocarbon having seven to twenty seven carbons, in particular, fifteen to twenty carbons, or specifically seventeen carbons. R4 can be CH₃ or H, while n is 1 to 100 or 1 to 5 and m is 1 to 10. M can be Si or Sn. R5 and R6 can each be independently selected from H, an alkyl group (e.g., CH₃, C₂H₅, CH₂CF₃), or an aryl group (e.g., C₆H₆). In addition, R5 and R6 can each be independently selected from Q, as described above, and a photo cross-linkable moiety, such as one described herein. In an embodiment, the benzophenone group can be replaced with another photo cross-linkable moiety, so a large number of compounds are considered to be described by this disclosure.

W can be a poly(hexamethylene biguanidine) with ammonium and cyanoguanidine termination groups, as represented below:

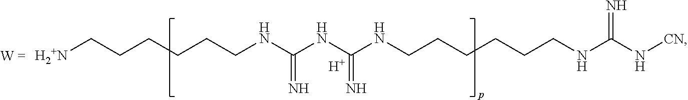

where p is 1 to 100 or 5 to 25. In an embodiment, the benzophenone group can be replaced with another photo cross-linkable moiety, so a large number of compounds are considered to be described by this disclosure.

Prior to reacting the photo cross-linkable moiety above, R7 can be bonded to X, where X is displaced so that W bonds to R7. X can be a halogen or an alkyl halide.

As noted above, the compound can be covalently bonded to a structure. In an embodiment, the article including the compound can be represented as: R11-(C(Struc)OH)-R12-X—W. R11, R12, X, and W are defined herein. “Struc” can include structures defined herein that include C—H functionality. A few exemplary embodiments of articles bound to the compound are described below.

As mentioned above, the compound can be disposed on a surface to produce a structure that includes the compound covalently bonded (via a photochemical process) to the surface of the structure. In an embodiment, the method of disposing the compound on the surface of the structure includes disposing the compound on the surface using a method such as spraying, dipping, spin coating, drop casting, and the like. In an embodiment, the surface of the structure has C—H groups that can interact (e.g., form C—C bonds) with the compound upon exposure to UV light. In an embodiment, the structure has a layer (also referred to as a “functionalized layer”) (e.g., a thin film or self assembling layer) disposed on the surface of the structure. The functionalized layer includes C—H bonds that can interact (form C—C bonds) with the compound upon exposure to UV light. The structure can be exposed to UV light in many different ways such as direct exposure to a UV light source, exposure to UV light during the spray coating process, exposure to UV light during the dip coating process, exposure to UV light during the spincoating process, exposure to UV light during dip padding, exposure to UV light during nip padding, exposure to UV light during kiss rolling, and exposure to UV light during the drop-casting process.

Either during application of the compound or once the compound is disposed on the surface, UV light is directed onto the compound on the surface. As described above, the UV light causes a photochemical reaction to occur between the compound and the surface to form one or more covalent bonds (C—C bonds) between the compound and the surface.

The wavelength of the UV light can be selected based on the photo cross-linkable moiety. In general, the UV light can be active to form the C—C bonds at about 250 to 500 nm, about 340 to 400 nm, or about 360 to 370 nm. The specific wavelength(s) that can be used for a particular photo cross-linkable moiety are described herein. In an embodiment, the UV light can be active to form the C—C bonds at a wavelength of about 340 to 370 nm. In an embodiment, the UV light can be active to form the C—C bonds at a wavelength of about 365 nm.

After the compound is covalently bonded to the surface, the structure has an antimicrobial characteristic that is capable of killing a substantial portion of the microorganisms (e.g., bacteria, virus, or a combination of different types of microorganisms) on the surface of the structure and/or inhibits or substantially inhibits the growth of the microorganisms on the surface of the structure. The phrase “killing a substantial portion” includes killing at least about 70%, at least about 80%, at least about 90%, at least about 95%, or at least about 99% of the microorganism (e.g., bacteria, virus, or a combination of different types of microorganisms) on the surface that the compound is covalently bonded. The phrase “substantially inhibits the growth” includes reducing the growth of the microorganism (e.g., bacteria, virus, or a combination of different types of microorganisms) by at least about 70%, at least about 80%, at least about 90%, at least about 95%, or at least about 99% of the microorganisms on the surface that the compound is covalently bonded, relative to a structure that does not have the compound disposed thereon.

In an embodiment, the compound can be represented by the following structure.

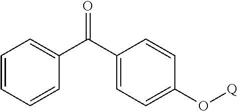

Q is an antimicrobial moiety as described herein.

The following are exemplar embodiments.

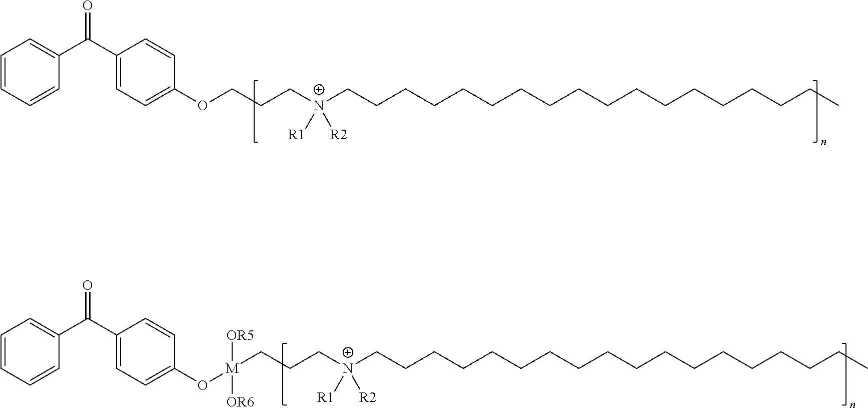

As mentioned above, the compound can be attached to a surface of a structure as represented below.

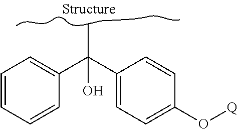

The structure can inherently include C—H bonds on the surface and/or include a functionalized layer on the surface of the structure.

In another embodiment, the compound can be represented by the following structure.

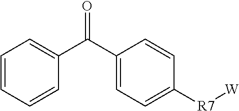

R7 can be (CH₂)_{z}, where z is 1 to 6. W can be a poly(hexamethylene biguanidine) with ammonium and cyanoguanidine termination groups.

Prior to reacting the benzophenone compound above, R7 can be bonded to X, where X is displaced so that W bonds to R7. X can be a halogen or an alkyl halide.

As mentioned above, the compound can be attached to a surface of a structure as represented below.

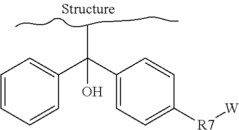

The structure can inherently include C—H bonds on the surface and/or include a functionalized layer on the surface of the structure.

In regard to the discussion herein including the Examples above and the claims, it should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include rounding according to the measurement technique and the numerical value. In addition, the phrase “about ‘x’ to ‘y’” includes “about ‘x’ to about ‘y’”.

Many variations and modifications may be made to the above-described embodiments. All such modifications and variations are intended to be included herein within the scope of this disclosure and protected by the following claims.

1. A compound comprising, a photo cross-linkable moiety and an antimicrobial moiety (AM).

2. The compound of claim 1, wherein the photo cross-linkable moiety and an antimicrobial moiety are defined by the following: R11-(C═O)-R12-X-(AM), where R11 and R12 are independently selected from the group consisting of: H, a substituted or unsubstituted aliphatic group, a substituted or unsubstituted aryl group, and a substituted or unsubstituted heteroaryl group; X is selected from the group consisting of: O, NR13, a substituted or unsubstituted alkyl group, an S group, a SR13 group, a substituted or unsubstituted aryl group, and a substituted or unsubstituted heteroaryl group; wherein R13 is selected from the group consisting of: H, a substituted or unsubstituted aliphatic group, a substituted or unsubstituted aryl group, and a substituted or unsubstituted heteroaryl group.

3. The compound of claim 1, wherein one of R11 and R12 is a substituted or unsubstituted aryl group.

4. The compound of claim 1, wherein both of R11 and R12 is a substituted or unsubstituted aryl group.

5. The compound of claim 1, wherein one of R11 and R12 is a substituted or unsubstituted phenyl group.

6. The compound of claim 1, wherein both of R11 and R12 is a substituted or unsubstituted phenyl group.

7. The compound of claim 1, wherein the antimicrobial moiety is selected from Q, W, and a combination thereof: 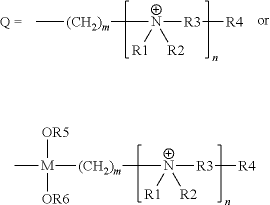
where R1 and R2 are independently selected from the group consisting of: H, a substituted or unsubstituted aliphatic group, a substituted or unsubstituted aryl group, and a substituted or unsubstituted heteroaryl group, R3 is a linear hydrocarbon having seven to twenty seven carbons, R4 is CH₃ or H, while is n is 1 to 100 or 1 to 5 and m is 1 to 10; M is Si or Sn; where R5 and R6 are independently selected from the group consisting of: H, a substituted or unsubstituted aliphatic group, a substituted or unsubstituted aryl group, a substituted or unsubstituted heteroaryl group, another Q group, and a photo cross-linkable moiety; 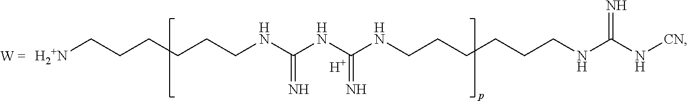
where p is 1 to 100, where a bond to AM is formed at the N of the H₂N⁺ side of W.

8. The compound of claims 7, R5 and R6 can each independently selected from Q and a photo cross-linkable moiety.

9. The compound of claim 7, the photo cross-linkable moiety and the antimicrobial moiety are part of the following structure: 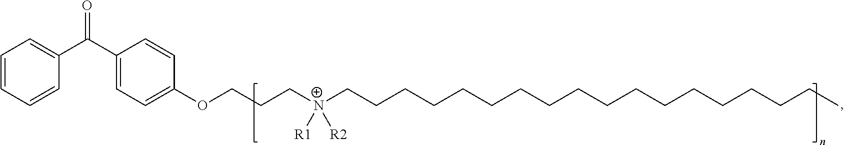
where n is 1 to 100.

10. The compound of claim 7, the photo cross-linkable moiety and the antimicrobial moiety are part of the following structure: 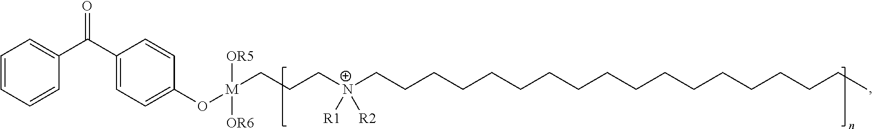
where n is 1 to 100.

11. The compound of claim 7, the photo cross-linkable moiety and the antimicrobial moiety are part of the following structure: 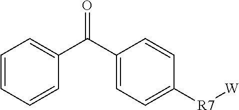
R7 can be (CH₂)_{z}, where z is 1 to 6.

12. An article, comprising a compound having a photo cross-linkable moiety and an antimicrobial moiety (AM).

13. The article of claim 12, wherein
R11-(C(Struc)OH)-R12-X-(AM), where R11 and R12 are independently selected from the group consisting of: H, a substituted or unsubstituted aliphatic group, a substituted or unsubstituted aryl group, and a substituted or unsubstituted heteroaryl group; X is selected from the group consisting of: O, NR13, a substituted or unsubstituted alkyl group, a S group, a substituted or unsubstituted aryl group, and a substituted or unsubstituted heteroaryl group; wherein R13 is selected from the group consisting of: H, a substituted or unsubstituted aliphatic group, a substituted or unsubstituted aryl group, and a substituted or unsubstituted heteroaryl group, and wherein Struc is a structure having C—H functionality.

14. The article of claim 13, wherein the structure is selected from the group consisting of: a polypropylene fiber, a polyethylene fiber, a polyester fiber, a polyamide fiber, an aramid fiber, a cellulose fiber, a hemicellulose fiber, an acrylic fiber, a latex fiber, and a natural fiber.

15. The article of claim 13, wherein the structure is a textile article.

16. The article of claim 13, wherein the structure is selected from the group consisting of: a counter top, processing equipment, a utensil, a food packaging material, a metal, a plastic structure, a medical instrument, a medical implant, a diaper, leather, and flooring.

17. The article of claim 13, comprising 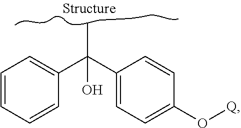
wherein the dark curvy line is the surface of the structure.

18. The article of claim 13, comprising 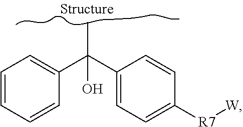
wherein the dark curvy line is the surface of the structure.

19. The article of claim 13, wherein the structure is a fiber made of a material selected from: polyethylene, polyester, aramid, polyamide, cellulose, hemicellulose, acrylic, latex, and a combination thereof.
